(19) United States
(12) Patent Application Publication
(10) Pub. No.: US 2013/0218780 A1
(43) Pub. Date: Aug. 22, 2013

(54) System and Method for Digitally Monitoring Construction Project Progress

(71) Applicant: Leonard Buzz, Spring, TX (US)

(72) Inventor: Leonard Buzz, Spring, TX (US)

(73) Assignee: ON CENTER SOFTWARE, INC., The Woodlands, TX (US)

(21) Appl. No.: 13/399,608

(22) Filed: Feb. 17, 2012

(51) Int. Cl. G06Q 10/06

(52) U.S. Cl. 705/301

(57) ABSTRACT

A method for tracking progress of a construction project comprising storing digital representations of construction drawings and storing information about material costs and amounts of labor needed to build each condition assembly in the drawing. Once the construction project begins, the method allows for a user to enter real time information about status of completion of work on each labor cost code for a selected area and the amount of labor and materials used to achieve that. The program then calculates the percentage of progress of work on each labor cost code, determines whether the labor cost code is on a projected budget and presents the results in color coded format on the drawing and/or on the list of labor cost codes.

### TECHNICAL FIELD

The present invention relates to management of construction projects, and in particular to techniques for monitoring the progress of a construction project and determining whether the project is on budget.

### BACKGROUND

Construction professionals generally use computer software programs to more efficiently bid on large construction projects. Some of these construction software programs provide capabilities for drawing or uploading construction plans and/or engineering drawings. The software programs also allow a user to enter a list of condition assemblies that are required to be completed for a particular construction project. Condition assembly refers to each separate component of the construction project that needs to be built or installed, such as a ceiling, exterior structure, door, or a particular type of wall. Completing each condition assembly may require performance of multiple labor activities and use of various materials. The software programs allow the user to enter a list of labor activities and materials that are needed for each condition assembly. Some of the construction software programs currently used by construction professionals also enable the user to enter an estimated amount of cost for materials and labor needed to complete each condition assembly.

For each condition assembly entered into the software program, a user can create one or more objects on the construction drawings, where each object represents the particular condition assembly with which it is linked. The resulting file quantifies the condition assemblies and costs associated with them and as a result can calculate a projected cost for the entire project. This enables the construction professional using such a program to efficiently prepare an estimate or bid for the construction project.

Once a bid is accepted and the construction project begins, the same software program can be used to assist a construction manager in monitoring and managing the project. For example, an onsite manager can view the construction drawings on a tablet, handheld PC, or other mobile device. That information may be useful in giving the project manager a general overview of the project, but it may not provide enough detail to detect budgetary or other problems in the project early on. For example, that system would not provide enough information to permit the project manager to detect when a labor activity is not being produced at the estimated production rate. That can be problematic because by the time the lower production rate is realized, it might be too late in the construction process to address it, as the labor budget may already have been expended for that task.

Thus, it would be desirable to implement an efficient method to monitor the progress of a construction project and in real time, thereby providing management with timely information to make adjustments that might allow them to prevent cost overruns.

### SUMMARY

In one embodiment, a method for tracking progress of a construction project is disclosed. The method includes storing digital representations of one or more construction drawings where the digital representations include information about material costs and the type of labor activity needed to complete each condition assembly represented in the drawings. Once the construction project begins, the method allows a user to enter real time information about progress of work for each labor activity and the amount of labor and materials used at that point to achieve that progress. The program then compares the projected labor budget for each labor activity with actual work-in-place labor expended on a labor activity. The results of this comparison are presented in color coded format on the drawings and/or on a list of labor activities to show what, where and how fast materials are being installed and/or labor activity is being performed.

### BRIEF DESCRIPTION OF THE DRAWINGS

FIG. 1 is a diagram illustrating an exemplary user interface screen for a construction software program showing a construction drawing and its related information.

FIG. 2 is a diagram illustrating an exemplary user interface screen for a construction software program showing properties for a condition assembly in the construction drawing.

FIG. 3 is a diagram illustrating an exemplary user interface screen for the construction software program providing detailed information for a condition assembly in the drawing.

FIG. 4A-4C are diagrams illustrating exemplary user interface screens for the construction software program providing the user with an ability to enter percentage of completion for labor cost codes and presenting color coded information to show the status of a labor cost code's budget.

FIG. 5 is a diagram illustrating an exemplary employee timecard in accordance with one aspect of the present invention.

FIGS. 6A-6B are diagrams illustrating an exemplary budget table showing labor activities for labor cost codes in the construction project and their corresponding projected and actual amounts of labor.

### DETAILED DESCRIPTIONS

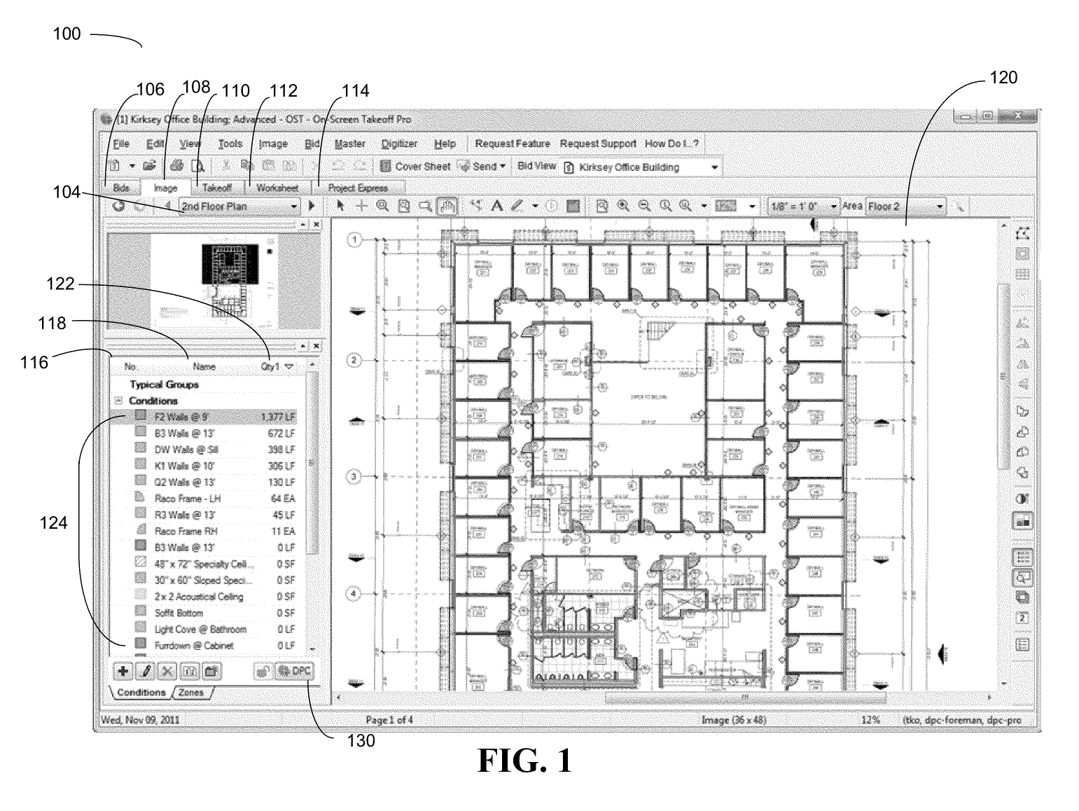

FIG. 1 illustrates an exemplary user interface screen 100 used in a construction project software which incorporates a preferred embodiment of the present invention. Generally, a first step in using this software program is to create or upload one or more engineering or construction drawings into the program. The construction drawings for each project generally include all the building areas in the project and representations for all the various condition assemblies in each building area. The term building area, as used in this specification, refers to each section of the project. For example, the first floor, second floor and third floor are each considered a separate building area for a construction project involving an office building. The term condition assembly refers to each separate component of the construction project that needs to be completed. For example, a wall, a door frame, or ceiling is each considered a separate condition assembly. Generally, to complete each condition assembly, a number of labor activities are performed and some materials are used. The term labor activity is used to refer to each type of task needed for the completion of a condition assembly. For example, completing a wall involves labor for framing the wall, labor for hanging wallboard on the wall, and labor for finishing the wall. Different labor cost codes are used in the program to refer to known labor activities. For example, the term “HANG LOW” is used to refer to the labor activity of attaching wallboard to the framing below the room ceiling height.

The user interface screen 100 includes various buttons and drop down menus that provide a variety of options for different views and processing of construction related information. For example, screen 100 includes a button 106 for choosing to view the Bids, a button 108 to view the Image, a button 110 for viewing quantity totals in Takeoff, a button 112 to view an estimating Worksheet, and a button 114 to view the Project Express for sending and receiving bids. As shown in FIG. 1, selected Image button 108 provides a view of a construction drawing 120. Additionally, a dropdown menu 104 allows the user to select which page or area of the construction project to view. The selected portion can be any part of the construction project for which a separate construction drawing exists. For example, the dropdown menu selected in screen 100 is the 2^{nd} Floor Plan and the corresponding drawing 120 includes all the various condition assemblies in the 2^{nd} Floor for this construction project. The drawing 120 by itself, however, is just a two dimensional drawing and does not include any objects that have underlying values. Objects are created on the drawing during the quantity Take Off process.

The quantity take off is a process performed by estimators in a construction project to determine an estimated cost for the project. The process involves counting or quantifying all condition assemblies for the project. For example, for the condition assembly of interior doors, all required interior doors are counted. In the construction project software of the preferred embodiment, this process can be performed by selecting a condition assembly from the view pane 116 and clicking on places and/or areas on the drawing 120 that correspond to the selected condition assembly. By doing so, an object that corresponds to the selected condition assembly is created on the drawing. The object is generally represented by a colored line or shape, depending on the type of the condition assembly and is linked to the corresponding condition assembly. For conditions that are counted by their quantity such as doors and windows, merely clicking on a spot on the drawing creates a colored representation of that condition. For objects that are quantified by their length, such as walls, a line is usually drawn on the drawing to represent the wall. The software then automatically counts or measures the objects on the drawings to provide a quantity for each condition assembly. This achieves two objectives, one is quantifying the condition assemblies in the project, and the other is creating live objects on the drawings that have underlying values and are linked to corresponding condition assemblies.

The two dimensional image shown in the drawing 120 can also be three dimensional (3D) such as a 3D CAD drawing, Building Information Modeling (BIM), or the like. Using a 3D drawing is advantageous in that the user can view each of the various building areas in a manner that is closer to the actual shape and design of the buildings. Thus, the user can examine each labor activity involved in completing a particular building area or condition assembly more easily. A 3D drawing is particularly useful in examining height. For example, an office building may have a hallway area that has a 30 foot ceiling and office areas that have 10 foot ceilings. Illustrating this difference in height in a two dimensional drawing is difficult and not readily noticeable. A 3D drawing, however, can more easily show this difference. 3D drawings also have other properties that make them particularly advantageous for use in the preferred embodiment of the present invention. For example, some 3D model drawings include objects that have built-in associated quantities. The quantities can include the size or quantity of the object and the associated labor activities and materials required to complete the object. Thus, a quantity Take Off process of creating objects is not necessary in some 3D models. As will be seen later, the built-in information is useful in determining percentage of progress for a labor cost code.

Referring back to the user interface screen 100 of FIG. 1, the screen allows the user to click on each line or item in the drawing 120 to select a particular condition assembly in the drawing. For example, the user can click on and select a particular type of wall, such as the “F2 Walls@9’” walls selected in FIG. 1. When selected, the associated entry for the selected condition assembly becomes highlighted in the view pane 116. The view pane 116 also displays a list of names 118 of all condition assemblies 124 in the drawing 120 and a corresponding column Qty1 122 for each condition assembly. The column Qty1 122 represents a unit of measurement associated with each condition assembly in the drawing 120.

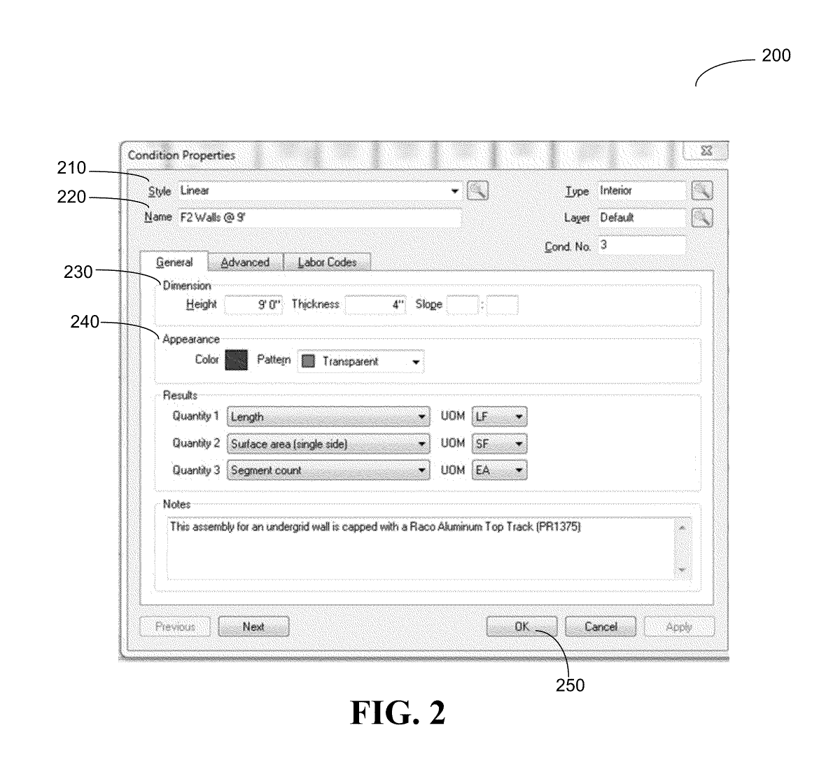

Clicking on or otherwise selecting a condition assembly in the view pane 116 brings up a window for reviewing or setting properties for that condition assembly. For example, clicking on F2 Walls@9’ in the view pane 116, brings up the properties window 200 of FIG. 2. The condition properties window 200 includes entries for style 210 and name 220. The style 210 enables the user to select a unit of measurement for the condition assembly. The name 220 allows the user to change or select a name for the condition assembly. Entries for dimension 230 allow the user to select dimensions for height, thickness and slope of the condition assembly and entries for appearance 240 enable the user to select a color and pattern for objects that represent the condition assembly on the drawings. Other options are also presented in window 200. Once changes have been made to the desired properties, the user is taken back to the user interface 100 by clicking on the OK button 250.

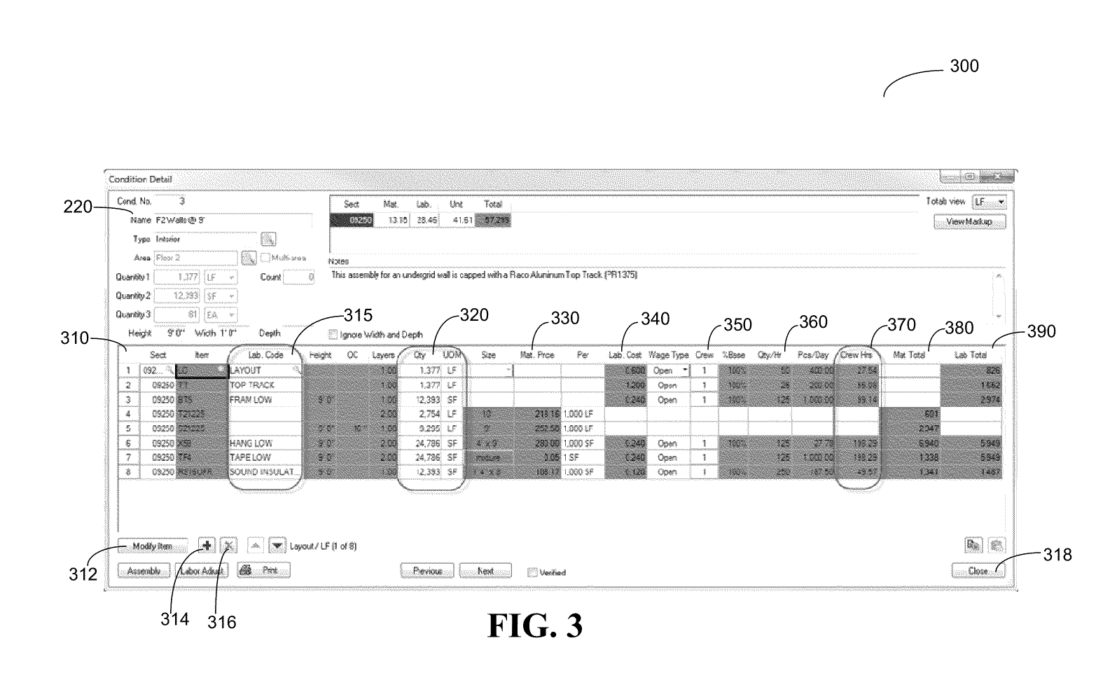

The list of condition assemblies provided in the construction project file of FIG. 1 can be used to create a cost estimate for the project. This is generally done by using a separate software program designed for estimating construction projects, such as the software program Quick Bid™, provided by On Center Software™, Inc. When a separate estimating program is used, a file is created in the estimating program containing detailed cost information for each condition assembly in the construction project file. This estimating file is linked to the file represented in interface screen 100. In an alternative embodiment, the features of the estimating program are integrated into the construction project software represented in FIG. 1. Whether using a separate estimating program or one in which estimating is integrated into the construction project software, the user is provided with the ability to view, enter and modify details for each condition assembly. Choosing to view details of a condition assembly takes the user to a Condition Detail screen such as the one illustrated in FIG. 3.

The Condition Detail screen 300 includes an entry 220 for entering the name of the condition assembly and a table 310 for entering all of the materials and labor cost codes associated with labor activities needed to complete the condition assembly. Table 310 includes a number of rows (numbered 1 through 8 in FIG. 3). Each row represents either a labor activity or material needed for completing the condition assembly. Table 310 also includes a number of columns that each contains information about the specific labor activity or material in each row. For example, a Lab. Code column 315 lists labor cost codes associated with labor activities needed for the condition assembly. If a row in table 310 relates to a material, not a labor activity, the column 315 would be left blank for that row. For example, rows #4 and 5 in table 310 relate to materials and as such their corresponding entries for column 315 are left blank. Table 310 also includes a column 320 for the quantity associated with material or labor activity of each row. Column 330 shows the costs associated with the material used for each row and column 340 illustrates the cost of labor per quantity for rows containing information about labor activities. Column 350 illustrates the number of employees needed for each labor activity. The estimated number of quantities installed/finished per hour is shown in column 360, and column 370 illustrates calculated number of crew hours needed to complete the labor activity associated with each row. Column 380 shows the total cost of materials for each row and column 390 illustrates the total cost of labor for each row.

The screen 300 provides the user with the ability to add a labor activity or material to table 310 by clicking on the add button 314. The user can also modify an item by clicking on button 312 or delete a row by clicking on button 316. Thus, the screen 300 enables the user to input for every condition assembly a list of all the materials and labor activities needed, and the time and cost associated with each labor activity or material in the list. After this information is entered for all condition assemblies in a project, the resulting estimating file can create a total estimate for the construction project. Since the file now includes detailed cost and labor information about the construction project, the same file can be used to manage and oversee the project.

One of the most important factors in successfully managing a construction project is to ensure that the project is proceeding on or under budget. However, determining whether or not a project is on budget is not easy. That determination is particularly difficult because production rates for a labor activity differ based on location, size, height and other variables of the condition assembly. The same labor activity may take much longer to accomplish on certain parts of the project than others. For example, installing 100 square feet of a ceiling grid at a 10 foot ceiling height is typically faster than installing the same 100 square feet of ceiling grid at a 30 foot ceiling height. Thus, if the project has a total 200 square feet of ceiling grid to install, half of which is at a 10 foot height and the other half at a 30 foot height, the estimate would generally allow a smaller number of labor hours for the low ceiling height than for the high ceiling height. For example, the estimate may allow 8 hours of labor for the 10 foot ceiling and 24 hours for the 30 foot ceiling. A carpenter working on the ceiling may use 8 hours to install the 100 square foot low ceiling and report to the manager that he has completed 50% of his job, as he has finished 100 of the 200 square feet. The carpenter's rate and labor cost code for the activity is probably the same for both the high and low ceilings. Thus reporting only that he has finished installing 100 square feet of the 200 square feet will provide the wrong impression that 50% of the ceiling job was completed in 8 hours, which would be considerably under budget. However, from a budgetary stand point, the ceiling job is not 50% complete but rather 25% complete, because although half of the physical space is finished, that half only represents 8 hours of the total 32 hours of labor estimated for this job. Thus, tracking the materials used and the type of labor activity performed, alone, does not provide an accurate estimate of whether or not the project is on budget.

An accurate estimate of whether or not the project is on budget is made in the preferred embodiment of the present invention, by treating labor activities separately if they have a different projected labor production rate. Thus, if the same labor activity, e.g. installing ceiling tiles, is being performed for the same condition assembly, but the labor activity has two different projected production rates, such as the two rates for the 100 foot and 30 foot ceilings example above, the program treats the labor activity as two cost codes with separate projected rates. Accordingly, an accurate and real time tracking of the project's progress and budget is achieved by tracking the varying production rates that were estimated for each individual length, area, and count segment of the construction drawings. This process is referred as the Digital Production Control (“DPC”).

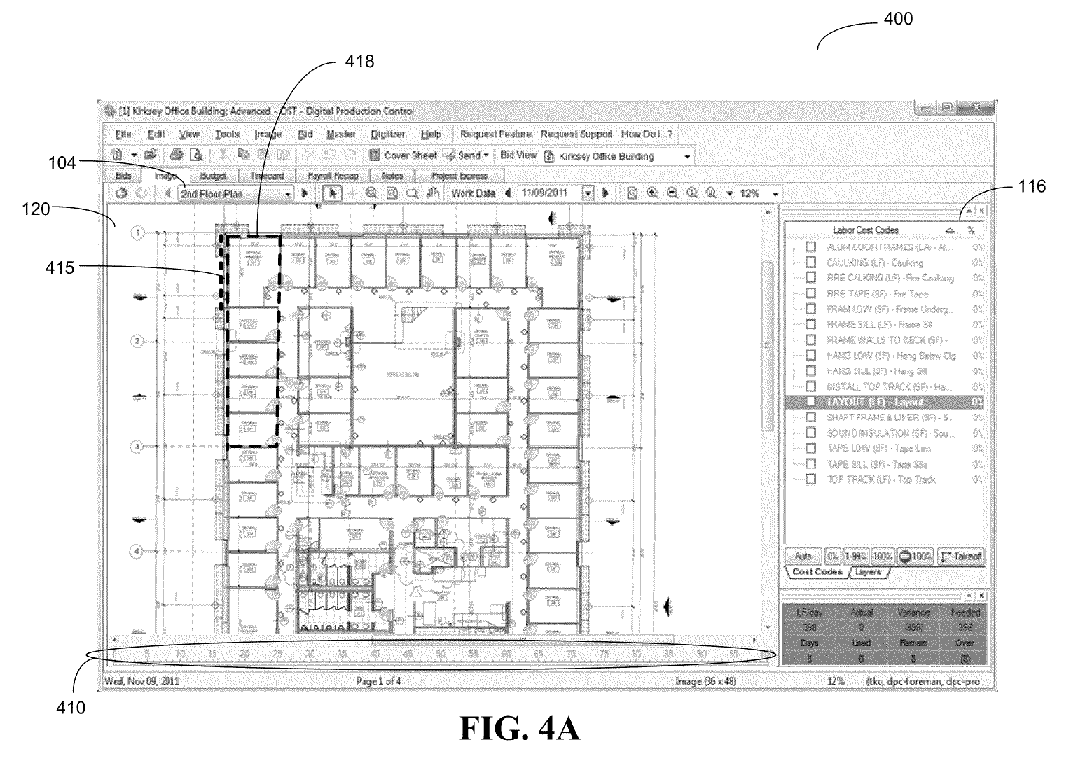

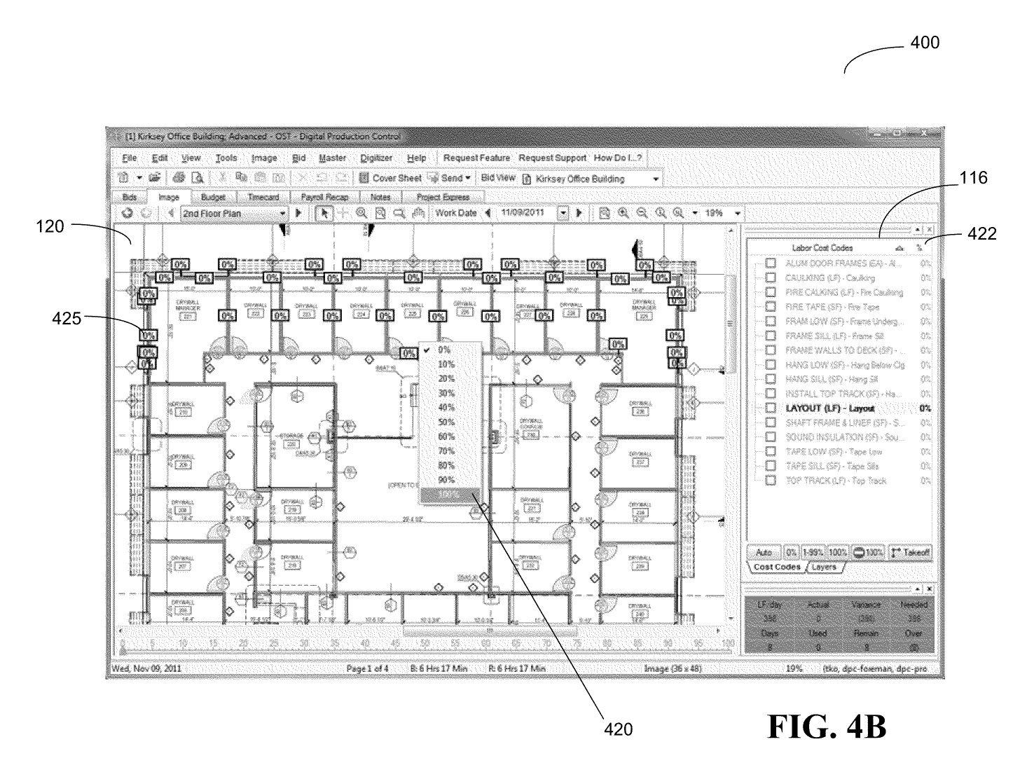

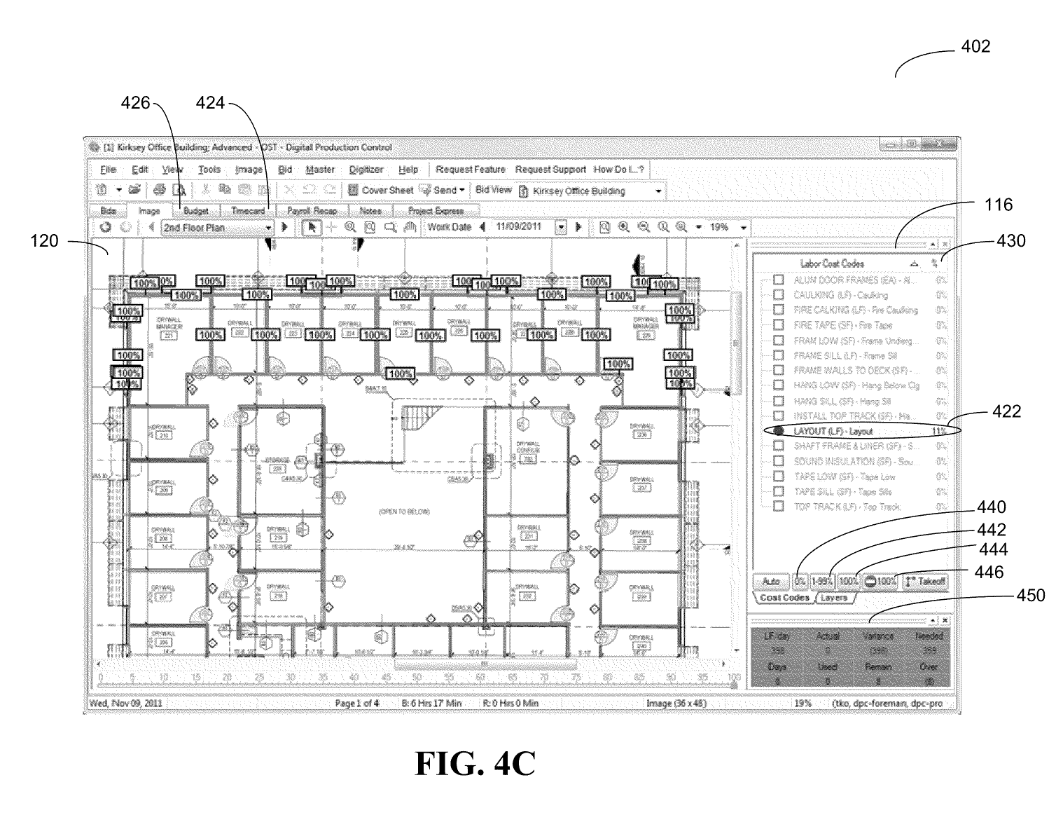

In the preferred embodiment of the present invention, an onsite manager has access to the software program and the electronic file of the construction project through a handheld PC, mobile computer, tablet, mobile phone application, or a similar device. Each day, the onsite manager selects to view the portion of the project on which work is being performed that day. For example, the manager may select to view the 2^{nd} floor ceiling by using the dropdown menu 104 (FIG. 1) and selecting the page of the construction project showing the 2^{nd} floor, as illustrated in FIG. 1. At the end of the work day or as the day progresses, depending on the needs of the project, the onsite manager may walk through the construction site to review and enter the project's progress into the program. By clicking on the DPC 130, the manager would be taken to screen 400 of FIG. 4A to enter this information.

The DPC screen 400 illustrates the selected drawing (in this case, drawing 120) and a view pane 116 which provides a list of labor cost codes involved in completing the condition assemblies included in the drawing 400. The DPC screen 400 also includes a percentage ruler 410 located at the bottom of the drawing 120. After selecting a labor cost code in the view pane 116, the manager chooses the portions of the drawing 120 on which the selected labor cost code was performed that day. This is done by clicking on an object on the drawing, for example the wall 415 (shown by a small dotted line). When clicked on, the wall 415 becomes highlighted and the user can then drag the pointer to expand the highlighted area, as illustrated by the highlighted area 418 (rectangular shaped area surrounded by dotted lines).

Once a labor cost code and an area are selected, the user can then click on the ruler 410 to select a percentage of completion. The percentage selected represents what percentage of the total labor activity (associated with the selected labor cost code) needed for the highlighted area was completed. For example, in FIG. 4A, selecting 50% on the ruler 410 indicates that 50% of the total LAYOUT (LF) labor cost code needed for the highlighted area was performed. This percentage is referred to as the percentage of completion. The percentage of completion is the percentage of completion of the labor activity for the selected labor cost code on a selected area. Once the percentage of completion is entered for a labor cost code, the program uses that percentage in an algorithm to calculate a percentage of progress for that labor cost code. The percentage of progress is the percentage of completion of the selected labor cost for the entire project, as opposed to the percentage of completion which is the percentage of completion of a cost code on a selected area. The percentage of progress is a weighted number calculated by taking into account the percentage of completion of the labor cost code on the selected area and the size of the selected area as compared to the total size of the area for which the selected labor cost code is required.

FIG. 4B illustrates an alternative method of selecting a percentage of completion for a selected area. Once a labor cost code and an area are selected, the user can view a percentage menu 420 by left clicking on one of the selected objects in the drawing 120. The selected area in FIG. 4B includes all objects that have a percentage box, such as the box 425, adjacent to them. The percentage box 425 represents the percentage of completion of the selected labor cost code on the object that is attached to the percentage box 425. As illustrated by the check mark next to 0% on the percentage menu 420, the percentage of completion previously selected for the LAYOUT (LF) labor on the selected area was 0%. Thus, the percentage boxes show 0%. If a different percentage of completion is selected in the menu 420, the percentage boxes would show that percentage.

Color coding or use of different shapes can also be used to indicate the status of completion of a labor cost code on an object. For example, different colors or shapes can be used to represent percentages of completions that fall within certain categories, such as done: 100% complete, not started: 0% complete, or in progress: anywhere between 0% to 100%. In another embodiment, different color lines are used. Various other embodiments are possible.

The percentage menu 420 of screen 400 shows that 100% is highlighted. That indicates 100% is now being selected for the percentage of completion of the LAYOUT (LF) labor task code on the selected area. Once 100% is selected, the box 425 and all the other percentage boxes shown in FIG. 4B will show 100% instead of the previous 0%. This is illustrated in FIG. 4C. Once a percentage of completion that is more than 0% is entered for a selected labor cost code on a selected area, the program calculates the percentage of progress for that labor cost code. The percentage of progress is illustrated in column 430 for each labor cost code. As shown in FIG. 4C, the percentage of progress for LAYOUT (LF) based on 100% completion of the selected area is 11%.

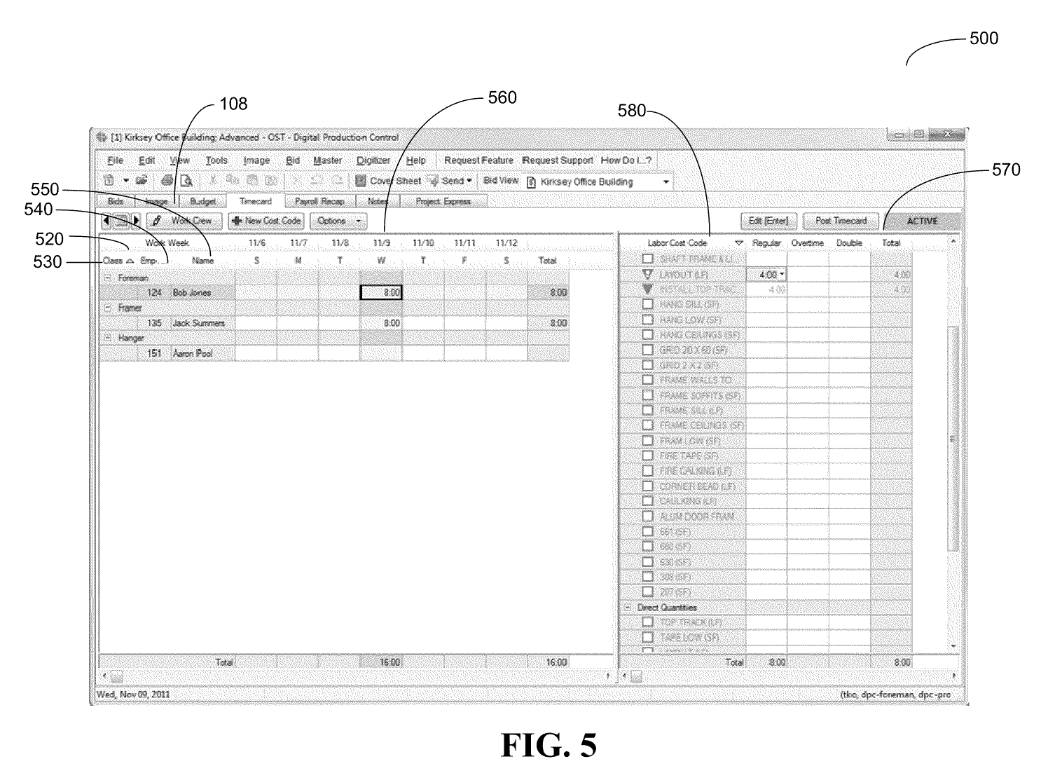

In addition to calculating the percentage of progress for each labor cost code, the DPC feature also enables the users to determine whether each portion of the project is on budget. This is done by entering the number of hours of labor and/or the amounts of material used to achieve the selected percentage of completion for each labor cost code. To do that, the user clicks on the Timecard button 424 to go to screen 500 of FIG. 5.

The screen 500 illustrates a table 520 which includes columns for the Class of employees 530, Employee number 540, Employee Name 550 and a calendar 560. Calendar 560 displays the days of the week and allows the user to enter the number of hours an employee worked each day. For example, employee Bob Jones who is classified as a foreman with the employee number of 124 worked eight hours on Wednesday 11/9. Another employee Jack Summers also worked eight hours on the same day. The table 520 allows the construction manager to enter and closely track each employee's hours of labor.

In addition to table 520, the screen 500 also displays a table 570 which allows the user to input the number of hours worked on each labor cost code. The number of hours entered in table 570 is not employee based, but instead they are entered for each labor cost code 580. For example, table 570 shows that four hours of labor was spent on the labor cost code LAYOUT (LF) and four hours was spent on INSTALL TOP TRAC. After the number of hours worked on each specific labor cost code is entered, the program is able to calculate whether or not the labor cost code is on budget.

Once the percentage of progress of a labor cost code is calculated and the number of hours of labor and/or amounts of material used on that cost code are also entered, the program compares those numbers with numbers entered into the condition detail screen 300 for each specific labor cost code to determine whether that portion of the project is under, over or on budget. For example, FIG. 3 shows that the total crew hours 370 required for the LAYOUT labor cost 422 is 27.54. FIG. 4C shows that the percentage of progress of the LAYOUT cost code 422 is 11% and the number of hours input into the timecard screen 500 for this work was 4 hours. Based on this information, the program calculates that for 11% of the LAYOUT cost code, the projected number of labor hours is 3.03 and compares that to the four hours of actual work input into table 570 to determine that the LAYOUT cost code is over budget at this point. Thus, the program automatically calculates for each labor cost code for which a percentage of completion and a related number of labor hours are entered whether the labor cost code is under, over or on budget. This information, along with all other information entered and calculated by the program can be communicated quickly between a main office and the onsite portable device via wired or wireless communications networks. Thus, both the onsite manager and a manager at the office can use the program to review performance in real time.

In a preferred embodiment of the present invention, the program uses mechanisms for visually identifying labor cost codes that are under budget, over budget or on budget differently. For example, different color codes are used in the drawing 120 and in the view pane 116 of screen 402 in FIG. 4C for labor cost codes that are over budget, under budget or on budget. In one embodiment, over budget labor cost codes are represented in red, labor cost codes that are on or under budget are represented in green, and labor cost codes on which work has not started are represented in blue. In another embodiment, over budget cost codes are represented in red, while cost codes that are on budget are represented in green, under budget cost codes are represented in yellow and cost codes on which work has not started are represented in blue. In yet another embodiment, the program differentiates between labor cost codes that are less than 5% over budget and those that are over 5% over budget by representing those two different categories in different colors. For example, labor cost codes that are less than 5% over budget are represented in orange, while labor cost codes that are over 5% over budget are represented in red. Various other color choices and configurations are possible. For example, different shapes may be used to represent items having different budgetary situations. In one embodiment, over budget items may be represented by solid lines while under budget items are shown in dashed lines. In the preferred embodiment of the present invention, the LAYOUT labor cost code is represented in red because, as discussed before, it is over budget. Thus, the entry 422 is represented in a red color font.

Additionally, when a labor cost code is selected, the corresponding areas on the drawing 120 for which work for that particular labor cost code has already started will be represented in a color corresponding to the status of that cost code's budget. In an alternative embodiment, color codes used in the drawing 120 may be different from those used in the view pane 116.

The visual identification of labor cost codes as being over, under or on budget allows the construction manager to instantly see if they are achieving, outperforming, or falling behind the estimated production rates for each particular labor cost code. By automatically displaying over budget labor cost codes in a different color, the preferred embodiment of the present invention helps the construction manager to immediately identify snags in production, and to see exactly what is happening in the field. Using this vital information, the manager is able make necessary adjustments to prevent cost overruns.

In addition to distinguishing the various labor cost codes based on their budgetary status by color coding them, the program also enables the user to view each different budget category separately by utilizing the buttons 440, 442, 444 and 446, shown in FIG. 4c. These buttons allow the user to display the portion of the labor cost codes that fall within each of the percentage categories displayed on the buttons. For example, clicking the button 440 causes the view pane 116 to display labor cost codes that have used 0% of the budget, while selecting the button 442 displays labor cost codes that are over 1% and under 99% complete and choosing the button 444 displays the cost codes that are 100% complete on budget. Selecting the button 446 displays the task codes that are 100% complete.

The screen 402 also includes a table 450 that displays the quantity per the unit of measurement for the selected labor cost code projected to be done per day, the actual quantity finished per day, the variance between the actual and the projected amount and the quantity needed to meet the projection. Table 450 also displays the projected number of days needed for completing the selected labor cost code, the number of days used, the number of days remaining, and the number of days over the projected number. This function allows the user to not only see how the project is progressing in terms of its adherence to budget, but also how it fares with respect to adherence to its projected timeline.

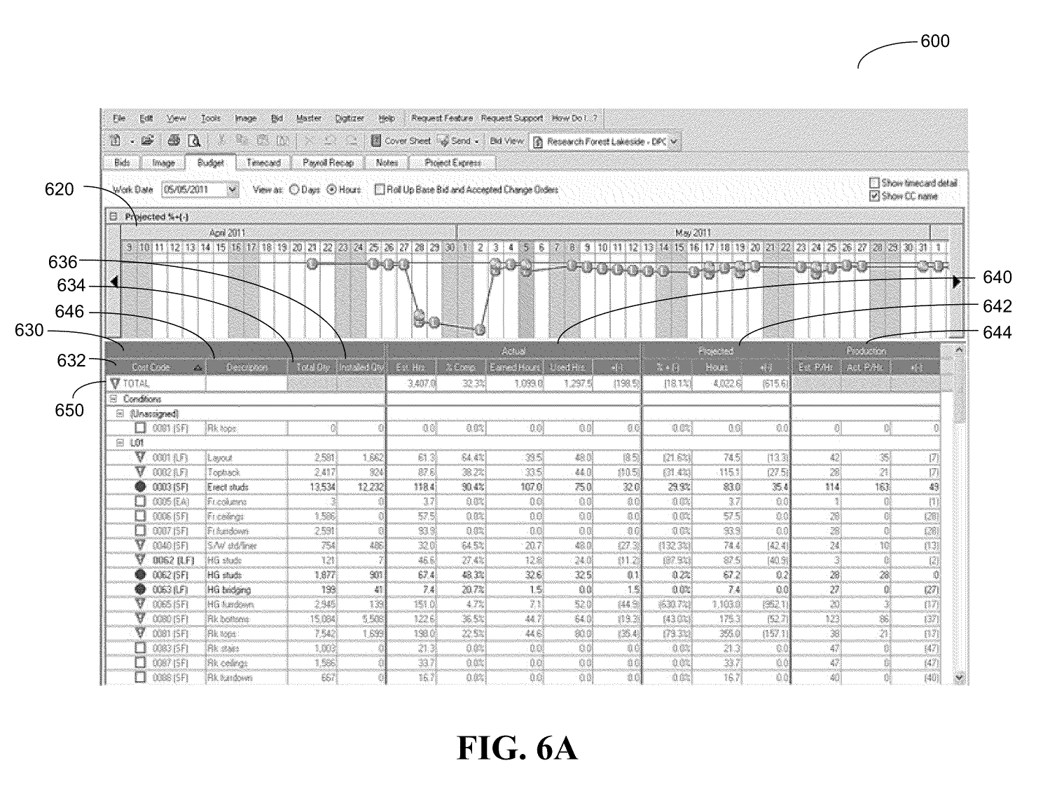

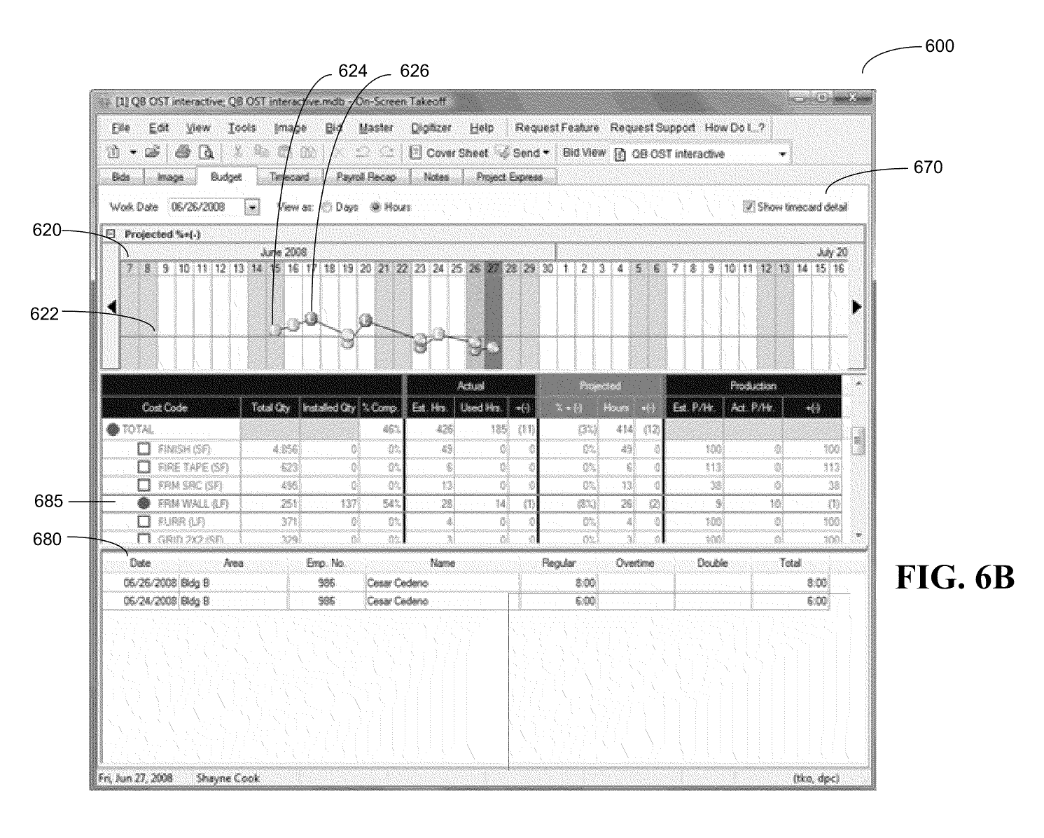

To view each labor cost code's status in more detail, the user can click on the budget button 426 to be taken to screen 600 of FIG. 6A. The screen 600 includes a calendar chart 620 and a budget table 630. The budget table 630 includes a list of cost codes (labor cost codes) 632, which are categorized by condition and/or building area and include a list of all labor cost codes for the project. For each of the listed cost codes 632, the table includes a column 634 for Total Qty and a column 636 for Installed Qty. Column 634 displays the total quantity (size) of the area on which a particular cost code must be performed. Column 636 displays the quantity (size) of the area on which each particular cost code has been performed.

Table 630 also includes a section for Actual numbers 640. The Actual numbers 640 section includes five columns, one for estimated hours, a column for percentage of completion: % Comp, one for earned hours, a column for used hours and a +(−) column that displays the difference between the actual and the estimated hours. The estimated hours column lists the estimated number of hours projected to complete a cost code for the entire quantity displayed in column 634. The % Comp column displays the percentage of progress of each cost code. The used hours column shows the actual hours used so far and the +(−) column represents the calculated variance between the estimated and the actual hours used.

Table 630 also includes a section 642 for the projected number of hours to complete the cost code in each row based on the information entered and calculated so far. This section uses the actual number of labor hours spent on each labor cost code and the percentage of progress for that cost code to calculate a real time projected number of hours needed to complete the cost code. The first column in section 642 represents a calculated percentage for being over/under budget in terms of hours of labor for each cost code. The second column, Hours, represents the currently projected number of hours needed to complete each cost code, and the +(−) column represents the variance between the originally estimated hours and the currently projected hours needed to complete the cost code.

Section 644 of table 630 shows Production rates. The first column represents the estimated production per hour rate for each cost code. The second column shows actual production per hour based on the information entered and calculated and the last column represents the variance between the actual and estimated production per hour rates.

In the preferred embodiment of the present invention, each row of table 630 is color coded in accordance with that cost code's status with respect to budget the same way labor cost codes were color coded in FIG. 4C. Thus, if a labor cost code is over budget, the information for that row is displayed in a different color than information for a row in which the cost code is under or on budget. Accordingly, each row of table 630 shows at a glance whether or not the labor cost code in that row is on budget, over budget or under budget.

A row 650 of table 630 shows the information for the entire construction project. Thus, row 650 at a glance illustrates the percentage of progress of the entire project, actual and estimated labor hours for the entire project and the variance between them, the projected number of labor hours needed to complete the entire project based on currently available information and the estimated and actual production rates for the entire project. The row 650 enables a construction manager to quickly assess the overall status of the project and whether or not it is on budget.

FIG. 6B illustrates the screen 600 when the check box 670 is checked to show timecard details. As shown, by checking the box 670 and selecting a cost code such as the cost code 685, a table 680 is displayed on the screen 600. The table 680 represents the details of the labor activity performed on the selected cost code. This detail includes the date, building area, employee number, name, and the number of hours worked by the employee, specifying whether the hours were regular, overtime, or double. This information helps the manager viewing the budget screen to obtain specific details about each cost code and can assist the manager in identifying areas of concern or sources of problems. For example, if there is a positive variance between estimated and used hours for two similar cost codes in table 630, the manager may select to see whether the same employees worked on these cost codes. If that is the case, the manager is able to identify workers that regularly underperform and can decide how to address the issue.

The calendar chart 620 of the screen 600 presents another way to observe the status of the project at a glance. Each circle on the calendar represents the overall status of labor activities performed on that day. Circles that are above the line 622 show that the labor cost codes performed that day are over budget, while circles below the line 622 represent that labor cost codes performed are under budget. Circles on the line 622 show that labor cost code for the specific day is on budget. In one embodiment, the circles are color coded to more clearly illustrate the status of each day's work with respect to budget. For example, circle 624 is represented in orange to show that the labor cost code performed on June 15^{th} was less than 5% over budget and circle 626 is represented in red to show that the labor cost code on June 17^{th} was over 5% over budget. In one embodiment, the color coding used for the calendar chart 620 corresponds with the color coding used in the rest of the program. In another embodiment, the color coding is different. In an alternative embodiment, the percentage values by which each day's labor cost code is either over or under budget is shown in each circle. This calendar shows how labor cost codes have been progressing over time and whether the project's efficiency has improved or declined.

Accordingly, this construction software program allows construction professionals to review in real time the progress of a construction project and provides them with sufficient and accurate real time detail to enable them to quickly identify and address problems.

As would be known to a person of ordinary skill in the art, the software program of the preferred embodiment of the present invention is generally stored in memory in a computer device and is run by a processor inside that computer.

It is to be understood that the above description is intended to be illustrative, and not restrictive. For example, the above-described embodiments may be used in combination with each other. Many other embodiments will be apparent to those of skill in the art upon reviewing the above description. The scope of the invention therefore should be determined with reference to the appended claims, along with the full scope of equivalents to which such claims are entitled. In the appended claims, the terms “including” and “in which” are used as the plain-English equivalents of the respective terms “comprising” and “wherein.”

What is claimed is:

1. A method for tracking percentage of progress of a construction project comprising:
accessing a digital representation of the project; the digital representation including digital images of one or more construction drawings, one or more condition assemblies for each construction drawing, and an estimated amount of labor for at least one labor activity needed to complete one of the one or more condition assemblies, wherein at least one of the construction drawings comprises a three dimensional drawing;
receiving a percentage of completion of the labor activity for a selected area of the one or more construction drawings;
receiving an amount of labor spent to complete the percentage of completion of the labor activity;
comparing the received amount of labor with the estimated amount of labor needed for the labor activity for the selected area;
calculating whether work on the labor activity is on budget based on a comparison between the received and the estimated amount of labor and on the percentage of completion of the labor activity; and
displaying an indication of whether the labor activity is on budget, over budget or under budget by color coding a representation of the labor activity on the digital images in accordance with its status of budget.

2. The method of claim 1, wherein the digital representation is communicated between a construction project site and a main office.

3. The method of claim 1, further comprising displaying the percentage of completion of the labor activity on one or more objects within the selected area on the construction drawings.

4. The method of claim 1, wherein the amount of labor received is a number of hours worked by each employee on the labor activity.

5. The method of claim 1, further comprising estimating whether the entire project will be on budget, over budget or under budget.

6. The method of claim 1, wherein the percentage of completion of the labor activity and the amount of labor is entered by an onsite user.

7. The method of claim 1, wherein at least one of the digital images further comprises a quantity projected to be done for the labor activity per a predetermined time period.

8. The method of claim 7, further comprising:
receiving a numerical value for a quantity of labor activity actually done per the predetermined time period;
displaying a difference between the projected and the quantity of labor activity done; and
displaying a calculated quantity of labor activity needed to be done per the predetermined period to finish on time.

9. The method of claim 1, further comprising displaying a projected number of days needed for completing the labor activity, a number of days used so far, and a number of days over the projected number.

10. A machine-readable storage medium comprising software that causes a processor
to:
access a stored digital representation of a construction project; the digital representation including digital images of one or more construction drawings and a projected quantity of labor and its corresponding costs for at least one labor activity needed to construct a building in accordance with the construction drawings, wherein at least one of the construction drawings comprise a three dimensional drawing;
receive a percentage of completion of work for the at least one labor activity on a selected area of the one or more construction drawings;
calculate a quantity of labor needed to complete the percentage of completion of work for the at least one labor activity on the selected area based at least in part on the projected quantity of labor and on a size of the selected area as compared to a total area on which the labor activity needs to be performed;
receive an actual quantity of labor spent to achieve the percentage of completion of work for the at least one labor activity on the selected area;
compare the calculated quantity of labor to the actual quantity of labor;
determine whether the at least one labor activity is on budget, over budget or under budget based on the comparison; and
display a status of budget for the labor activity on the one or more construction drawings by color coding the labor activity differently in accordance with its' status of budget.

11. The machine-readable storage medium of claim 10, wherein the processor further displays the percentage of completion of the at least one labor activity on one or more objects within the selected area on the construction drawings.

12. The machine-readable storage medium of claim 10, wherein the actual quantity of labor received is a number of hours worked by each employee on the at least one labor activity.

13. The machine-readable storage medium of claim 10, wherein the processor further estimates whether the entire project will be on budget, over budget or under budget.

14. A method for tracking percentage of progress of a construction project comprising:
accessing a stored digital representation of a construction project; the digital representation including digital images of one or more construction drawing and a projected quantity of labor and its corresponding costs for each labor activity needed to construct a building in accordance with the construction drawings, wherein at least one of the construction drawings comprise a three dimensional drawing;
receiving a percentage of completion of work for at least one labor activity on a selected area of the one or more construction drawings;
calculating a quantity of labor needed to complete the percentage of completion of work for the at least one labor activity on the selected area based at least in part on the projected quantity of labor and on a size of the selected area as compared to a total area on which the labor activity needs to be performed;
receiving an actual quantity of labor spent to achieve the percentage of completion of work for the at least one labor activity on the selected area;
comparing the calculated quantity of labor to the actual quantity of labor ;
determining whether the at least one labor activity is on budget, over budget or under budget based on the comparison; and
displaying a status of budget for the labor activity on the digital images by color coding the labor activity differently in accordance with its' status of budget.

15. The method of claim 14, wherein the digital representation is transferred from a construction project site to a main office.

16. The method of claim 14, further comprising displaying the percentage of completion of the at least one labor activity on the selected area on one or more objects within the selected area on the construction drawings.

17. The method of claim 14, wherein the actual quantity of labor received is a number of hours worked by each employee on the at least one labor activity.

18. The method of claim 14, further comprising estimating whether the entire project will be on budget, over budget or under budget.

19. The method of claim 14, wherein the percentage of completion of the at least one labor activity and the actual quantity of labor is entered by an onsite user.
